(19) United States
(12) Patent Application Publication
(10) Pub. No.: US 2016/0176730 A1
(43) Pub. Date: Jun. 23, 2016

(54) REMOVAL OF NITRATE FROM WATER

(71) Applicants: Soheil Bahrebar, Tehran (IR); Ali Mehdi Nia, Tehran (IR)

(72) Inventors: Soheil Bahrebar, Tehran (IR); Ali Mehdi Nia, Tehran (IR)

(21) Appl. No.: 14/944,360

(22) Filed: Nov. 18, 2015

(51) Int. Cl. C02F 1/48

(52) U.S. Cl. CPC C02F 1/488; C02F 2101/163

(57) ABSTRACT

The instant application describes a nanoparticle solution for reducing one or more impurities in stagnant water. The nanoparticles include a superparamagnetic solution. The superparamagnetic solution includes a solvent doped with a magnetizable particle and water. The nanoparticles also include a ligand molecular bound with the paramagnetic solution. The ligand is non-reactive with the paramagnetic solution. The ligand includes a binding agent such that the carrier sorbs one or more impurities.

### CROSS REFERENCE TO RELATED APPLICATION

This application claims the benefit of priority to an Iran patent application having Iran Patent Application Serial Number 139350140003009216, filed on Nov. 23, 2014 and issued as Iran Patent Number 84974 on Feb. 4, 2015, the entire content of which is incorporated herein by reference.

### TECHNICAL FIELD

The present application generally relates to removal of nitrate from water and more specifically relates to removal of nitrate from water samples by magnetic mesoporous silica nanoparticles.

BACKGROUND

The presence of large amounts of nitrate (NO₃⁻) in drinking water is one of the most serious concerns in the past few decades. The nitrate ion is readily soluble in water and is not linked with the soil and causes the soil to be highly susceptible to erosion. The high nitrate pollution in the water can deplete drinking water supplies. They can cause ecological change redundancy. Increased concentration of nitrate in drinking water induces a blue eye syndrome (Methemoglobinomia), especially in infants.

Hence, there is a need for an effective method to remove nitrate from water.

### SUMMARY

In one general aspect, the instant application describes a nanoparticle solution for reducing one or more impurities in stagnant water. The nanoparticles include a superparamagnetic material. The nanoparticles may include a molecular ligand bound with the superparamagnetic particles. The ligand includes mesoporous silica, called as MCM-41, which are amine-functionalized to sorb nitrate impurity from water samples.

The above general aspect may include one or more of the following features. The superparamagnetic particles may further include one or more Iron Oxide particles impregnated within a mesostructure of silica. The ligand may further include amino groups, which is produced through a reaction of (3-Aminopropyl) triethoxysilane (APTES) molecules with the superparamagnetic particles. The nanoparticle solution may further include a magnetic field generator. The modified ligand can bind to one or more NOx species.

In another general aspect, the instant application describes a method for reducing impurities in stagnant water. The method includes steps of generating a superparamagnetic particle; depositing the superparamagnetic particle into a carrier wherein the carrier is non-reactive with the superparamagnetic particle; injecting the deposited superparamagnetic particle in a [pool] of water; and generating a magnetic field to collect the deposited superparamagnetic particle.

The above general aspect may include one or more of the following features. The step of generating a superparamagnetic particle may further include impregnating amesoporous silica with iron oxide nanoparticles. The step of generating the superparamagnetic particle may further include impregnating the iron oxide particles with amino groups. The step of generating the superparamagnetic particle may further include binding an iron oxide particle with a mesoporous particle.

The step of depositing the superparamagnetic particle may further include depositing the superparamagnetic particle into a carrier that comprises amino groups. The step of depositing the superparamagnetic particle may further include binding the superparamagnetic particle with a reacted triethoxysilane particle. The method may further include a step of binding the injected deposited superparamagnetic particle with one or more anions of NOx. The method may further include a step of aminofying agent to bind one or more NOx chemical species.

### BRIEF DESCRIPTION OF THE DRAWINGS

FIG. 1 is a flow diagram representing a system for filtering water, according to at least one implementation of the disclosure.

### DETAILED DESCRIPTION

Illustrative implementations of the disclosure will now be described more fully herein after with reference to the accompanying drawings, in which some, but not all implementations of the disclosure are shown. The disclosure may be embodied in many different forms and should not be construed as limited to the implementations set forth herein; rather, these implementations are provided so that this disclosure will satisfy applicable legal requirements. Like numbers refer to like elements throughout.

References to “one implementation”, “an implementation”, “example implementation”, “various implementations”, and alike, may indicate that the implementation(s) of the application, so described, may include particular features, structures, or characteristics, but not every implementation necessarily includes all of the particular features, structures, or characteristics. Further, some implementations may have some, all, or none of the features described for other implementations.

As used herein, the term “species” refers to Chemical species including atoms, molecules, molecular fragments, ions, etc., being subjected to a chemical process or to a measurement. Generally, a chemical species can be defined as an ensemble of chemically identical molecular entities that can explore the same set of molecular energy levels on a defined time scale. Examples of species may include Nitrate ion, Zn atom or NO₂ molecule

The present application relates to a method for removing as much as 80% nitrate ions from the aquatic environment. The method involves combining Fe₃O₄ magnetic nanoparticles with the mesoporous silica MCM-41. The combination results in Fe₃O₄ being embedded by MCM-41. Then, silica material by (3-Aminopropyl)triethoxysilane (APTES) is added to the resulting combination to generate Fe₃O₄@MCM-41-NH₂. The formula (1) shows the chemical reaction.

Fe₃O₄+MCM-41 (→APTES) Fe₃O₄@MCM-41-NH₂ (Formula 1)

The magnetic mesoporous silica resulting from Formula 1 is added to the nitrate solution. The magnetic mesoporous silica may absorb the nitrate ions in the solution and then extracted from the solution via a magnet.

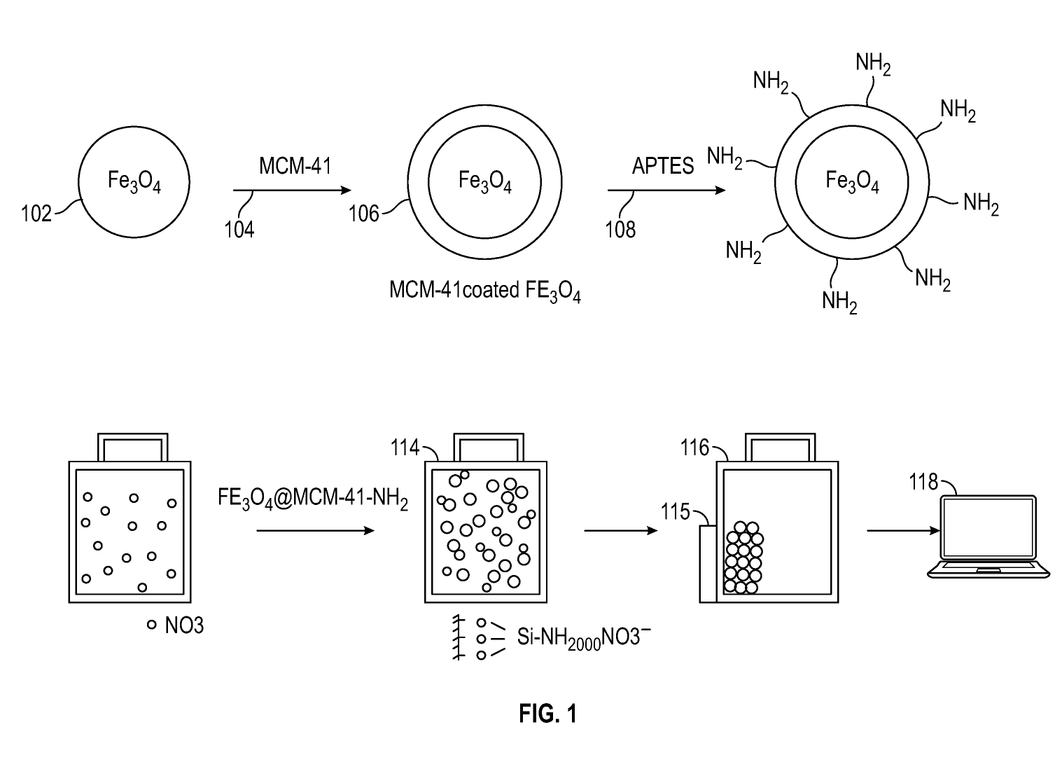

With respect to FIG. 1, an exemplary flow diagram 100 may begin with an introduction of a magnetic nanoparticle 102. The magnetic nanoparticle 102 may include Fe₃O₄ nanoparticles, in one specific example. In other examples, γ-Fe₂O₃; ferrites, such as MFe₂O₄ (M=Cu, Ni, Mn, Mg, etc.) can also be used as magnetic nanoparticles 102. The magnetic nanoparticles 102 may be covered by a shell.

In one specific example, the shell may be added to a solution containing the magnetic nanoparticles 102 (Step 104). With respect to the shell, surface-functionalized mesoporous silica materials may behave like porous sieves for host of pollutants of various sizes, shapes, charges and functionality. However, in the above illustration, mesoporous silica nanorods (MSNs) are activated through the binding of an MCM-41 with a metallic oxide. Presenting MCM-41 inside an aqueous solution may activate the shell. The shell covers or surrounds the Fe₃O₄ magnetic nanoparticles 102 to create a core 106. In these implementations, the core 106 is created by using MCM-41 coated Fe₃O₄. Moving forward, a ligand is added to the core (e.g., MCM-41 coated Fe₃O₄) 106 (Step 108). Adding the ligand to the core 106 creates superparamagnetic nanoparticle 110. A ligand may include of a 3-aminopropylsiloxy group and may be used as binding agent. The APTES may react with the core-shell molecule 106, and bind NHx groups within the matrix of the molecule. In the presence of an external magnetic field 116, these core-shell materials are attracted toward an external magnetic field. The superparamagnetic nanoparticle 110 may semi-autonomously or autonomously regulate the water system with respect to one or more toxins. Since each of the superparamagnetic nanoparticles 110 may bind to one or more toxins, the concentration of the superparamagnetic nanoparticles 110 may also be altered based on the levels of the toxins.

With respect to the activation of the superparamagnetic nanoparticle 110, generally metallic ions of various charges are used to create a core. The synthesis of a superparamagnetic nanoparticle 110 system that is based on using a MCM-41-type MSNs capped with superparamagnetic iron oxide nanoparticles, which are stimuli-responsive and chemically inert to guest molecules entrapped within the chemical structure.

Upon introduction of the superparamagnetic nanoparticle 110 into a stagnant water system 112, the superparamagnetic nanoparticle 110 may attract one or more pollutants to bind with the ligand. The ligand and the one or more pollutants form a stable bond with both the MSN and to each other. With respect to FIG. 1, upon introduction of a magnetic field 116 using a magnet 115, the superparamagnetic particles 110 may be excited. The magnetic field 116 may drive the superparamagnetic particles 110 in addition to any pollutants chemically bound to the superparamagnetic particles 110 to a location determined by the strength of the field. In one example, the magnetic field 116 may be varied anywhere between 1.0-1.4 T without changing or breaking any chemical bonds between the superparamagnetic particles 110, ligands and a pollutant.

Furthermore, the release of the particles and the collection of the particles may be varied or altered depending on the pH of a water molecule within the superparamagnetic particles 110 and the magnetic field 116. In one implementation, the amount of pollutants chemically bound to the superparamagnetic particles 110 may be measured by a measuring device 118. In another implementation, the pollutant chemically bound to the superparamagnetic particles 110 is removed and the remaining amount of pollutant in the water is measuring by the measuring device 118. In one specific example, the measuring device 118 shows 20% of the original amount of pollutant remaining in the water after the removal of the pollutant bounded to the superparamagnetic particles 110. In some implementations, a controller may be included as a part of the measuring device 118 or another device to alter the strength of the generated magnetic field 116 in response to the water pH or toxicity level. This may enable self-regulation, or semi-autonomous regulation of one or more pollutants within the water system.

Other implementations may include using an alternative ligand to target other pollutants within a water system such as chlorine, nitrites, toxic metals or other toxic inorganic compounds such as arsenic etc.

Other implementations of the disclosure may include introducing superparamagnetic particles 110 bound to one or more different types of ligands to target various toxins simultaneously. Furthermore, the generation of the superparamagnetic particles may use an alternative shell or a metallic oxide.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. The scope of protection is limited solely by the claims that now follow. That scope is intended and may be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, should may they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

What is claimed is:

1. A nanoparticle solution for reducing one or more impurities in stagnant water, the nanoparticle solution comprising:
a paramagnetic solution including a solvent doped with a magnetizable particle and water, wherein the magnetizable particle includes one or more Iron Oxide particles; and
a ligand configured to bind with the paramagnetic solution and to be added to a solution containing one or more impurities, the ligand including a binding agent configured to sorb the one or more impurities, wherein:
the solvent further includes a mesoporous particle, and
the ligand includes (3-Aminopropyl)triethoxysilane (APTES).

2. The nanoparticle solution of claim 1, wherein the one or more Iron Oxide particles are impregnated within a mesostructure of the solvent.

3. The nanoparticle solution of claim 1, wherein the mesoporous particle includes an MCM-41.

4. The nanoparticle solution of claim 1, wherein the nanoparticle solution is subjected to a magnetic field generated by a magnetic field generator to separate the one or more impurities from the solution containing the one or more impurities.

5. The nanoparticle solution of claim 1, wherein the one or more impurities include one or more NOx anions.

6. A method for reducing impurities in stagnant water, the method comprising:
impregnating a ligand with an iron oxide particle to generate a core particle;
impregnating the core particle with (3-Aminopropyl)triethoxysilane (APTES) to generate a superparamagnetic particle;
depositing the superparamagnetic particle in a stagnant water for reducing impurities within the stagnant water, wherein the deposited superparamagnetic particle is configured to bound with the impurities within the stagnant water;
generating a magnetic field to collect the impurities bounded with the superparamagnetic particle in a direction of the magnetic field; and
extracting from the stagnant water the impurities bounded with the superparamagnetic particle.

7. The method of claim 6, wherein the step of generating the core particle further comprises binding the iron oxide particle with a mesoporous particle.

8. The method of claim 6, wherein the impurities include one or more particles of NOx.

9. The method of claim 6, further comprising deactivating the superparamagnetic particle.

10. The method of claim 6, further comprising measuring via a measuring device an amount of impurities remaining in the stagnant water subsequent to the extraction step.
